(19) United States
(12) Patent Application Publication
(10) Pub. No.: US 2026/0238977 A1
(43) Pub. Date: Aug. 13, 2026

(54) PROVIDING TEXT-TO-911 SERVICES FOR ROAMING WIRELESS DEVICES

(71) Applicants: AT&T Intellectual Property I, L.P., Atlanta, GA (US); AT&T Mobility II LLC, Atlanta, GA (US)

(72) Inventors: Mario Jardon, Pembroke Pines, FL (US); Sreejith Menon, Chantilly, VA (US); Rajeev Singh, Monrovia, MD (US); Ashish Dhital, Bellevue, WA (US); Peter Pak, Woodinville, WA (US); Nathan Stowell, Lake Stevens, WA (US)

(21) Appl. No.: 19/051,144

(22) Filed: Feb. 11, 2025

(51) Int. Cl. H04W 4/90; H04L 65/1045; H04L 65/1096; H04L 65/70; H04M 3/51; H04W 4/14; H04W 8/08

(52) U.S. Cl. CPC H04W 4/90; H04L 65/1045; H04L 65/1096; H04L 65/70; H04M 3/5116; H04W 4/14; H04W 8/08

(57) ABSTRACT

A method for providing text-to-911 services for roaming wireless devices includes receiving, from a roaming user endpoint device in a wireless communications network, a session initiation protocol message containing a text message to emergency services, retrieving, from a policy and charging rules function of the wireless communications network, an identity of the roaming user endpoint device, modifying a header of the session initiation protocol message to include the identity of the roaming user endpoint device, and forwarding the session initiation protocol message, including the header as modified, to an internet protocol short message gateway of the wireless communication network for conversion to a short message peer-to-peer message and forwarding to a text to 911 control center.

The present disclosure relates generally to wireless communications networks, and relates more particularly to devices, non-transitory computer-readable media, and methods for providing text-to-911 services for roaming wireless devices.

### BACKGROUND

Next-generation 911 (NG911) and similar services allow individuals who are experiencing emergencies to make voice, text, or video calls from any communications device, via Internet Protocol (IP) networks. Compared to traditional 911 systems which typically allow voice calls with limited data delivered, NG911 provides faster, more flexible, more resilient, and more scalable responses to emergencies.

### SUMMARY

In one example, the present disclosure describes a device, computer-readable medium, and method for providing text-to-911 services for roaming wireless devices. For instance, in one example, a method performed by a processing system including at least one processor includes receiving, from a roaming user endpoint device in a wireless communications network, a session initiation protocol message containing a text message to emergency services, retrieving, from a policy and charging rules function of the wireless communications network, an identity of the roaming user endpoint device, modifying a header of the session initiation protocol message to include the identity of the roaming user endpoint device, and forwarding the session initiation protocol message, including the header as modified, to an internet protocol short message gateway of the wireless communication network for conversion to a short message peer-to-peer message and forwarding to a text to 911 control center.

In another example, a non-transitory computer-readable medium stores instructions which, when executed by the processing system, cause the processing system to perform operations. The operations include receiving, from a roaming user endpoint device in a wireless communications network, a session initiation protocol message containing a text message to emergency services, retrieving, from a policy and charging rules function of the wireless communications network, an identity of the roaming user endpoint device, modifying a header of the session initiation protocol message to include the identity of the roaming user endpoint device, and forwarding the session initiation protocol message, including the header as modified, to an internet protocol short message gateway of the wireless communication network for conversion to a short message peer-to-peer message and forwarding to a text to 911 control center.

In another example, a system includes a processing system including at least one processor and a non-transitory computer-readable medium storing instructions which, when executed by the processing system, cause the processing system to perform operations. The operations include receiving, from a roaming user endpoint device in a wireless communications network, a session initiation protocol message containing a text message to emergency services, retrieving, from a policy and charging rules function of the wireless communications network, an identity of the roaming user endpoint device, modifying a header of the session initiation protocol message to include the identity of the roaming user endpoint device, and forwarding the session initiation protocol message, including the header as modified, to an internet protocol short message gateway of the wireless communication network for conversion to a short message peer-to-peer message and forwarding to a text to 911 control center.

### BRIEF DESCRIPTION OF THE DRAWINGS

The teachings of the present disclosure can be readily understood by considering the following detailed description in conjunction with the accompanying drawings, in which:

FIG. 1 illustrates an example system in which examples of the present disclosure for providing text-to-911 services for roaming wireless devices may operate;

FIG. 2 illustrates a flowchart of an example method for providing text-to-911 services for roaming wireless devices, according to the present disclosure;

FIG. 3 illustrates a flowchart of an example method for providing text-to-911 services for roaming wireless devices, according to the present disclosure; and

FIG. 4 depicts a high-level block diagram of a computing device specifically programmed to perform the functions described herein.

To facilitate understanding, identical reference numerals have been used, where possible, to designate identical elements that are common to the figures.

### DETAILED DESCRIPTION

In one example, the present disclosure provides a system, method, and non-transitory computer readable medium for providing text-to-911 services for roaming wireless devices. As discussed above, next-generation 911 (NG911) and similar services allow individuals who are experiencing emergencies to make voice, text, or video calls from any communications device, via Internet Protocol (IP) networks. Compared to traditional 911 systems which typically allow voice calls with limited data delivered, NG911 provides faster, more flexible, more resilient, and more scalable responses to emergencies.

In modern NG911 systems, when a mobile user makes a request for emergency services (e.g., a call or text to 911), the user's endpoint device which is used to request the emergency services (e.g., the user's smart phone, tablet computer, autonomous vehicle, or the like) connects to a base station of an access network. The cell that is served by that base station is typically mapped to a specific public safety answering point (PSAP), which identifies and dispatches the appropriate first response personnel to respond to the emergency. For instance, the PSAP may identify the appropriate police department to respond to the emergency and either dispatch personnel from that police department or transfer the user's call to that police department.

Specifications defined by the Third Generation Partnership Project (3GPP) for Internet Protocol (IP) Multimedia Subsystem (IMS) emergency session support only address emergency voice calls using IMS. These specifications depend on the use of a local breakout architecture for the emergency access point name (APN) (in the case of long term evolution (LTE) network architectures), or the emergency data network name (DNN) (in the case of Fifth Generation (5G) network architectures). The APN or DNN is the gateway that connects a mobile device to a cellular communications network. The APN or DNN used specifically for emergency voice calling is an SOS (emergency) APN or SOS DNN, and the SOS APN/SOS DNN is used to derive a packet data network (PDN) gateway (PGW) (in the case of an SOS APN) or a user plane function (UPF) (in the case of an SOS DNN) in a cellular communications network that is serving a mobile device from which an emergency voice call originated.

Currently, roaming mobile devices (i.e., mobile devices being served by a “visited network,” or a network other than the “home network” to which the mobile device subscribes) use a home-routed architecture for normal IMS services, including text messaging. In a home-routed architecture, the PGW or home UPF for the IMS APN is always in the home network of a roaming mobile device. This means that a text message placed to 911 from a roaming mobile device will be processed and routed to a PSAP by the mobile device's home network, rather than the visited network. However, in a text-to-911 scenario, the home network may be unable to determine the PSAP that is closest to the mobile device (which will likely be located in an area served by a cell of the visited network), because the home network may be unable to determine the mobile device's location. This is because there currently exists no solution that enables all variants of short messaging services (SMS) to include mobile device location information, and current network-based location architecture does not allow a home network to initiate mobile terminated location requests (MT-LRs) to roaming mobile devices.

In many cases, when the home network receives a text-to-911 message from a visited network and is unable to determine the mobile device's location, the messaging core of the home network will send an error message (also referred to as a “bounce-back message”) to the mobile device instructing the user of the mobile device to call 911 (e.g., via voice or video call) for assistance. This solution not only delays connection of the mobile device user to emergency responders, but also potentially places the user in danger, since the user may not be in a position where they can openly or audibly contact emergency responders.

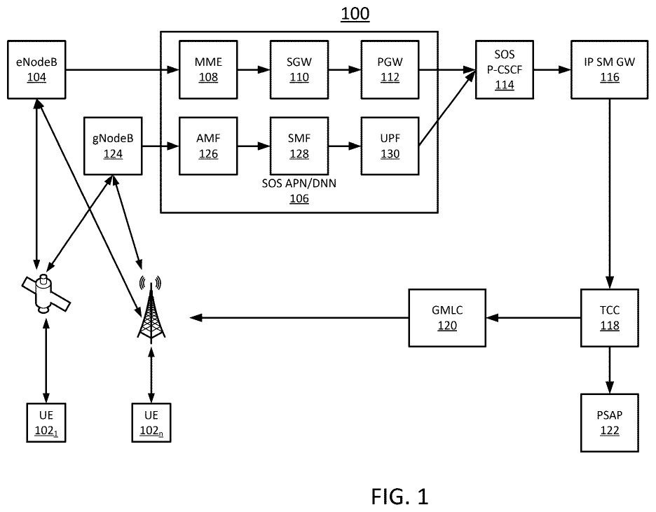

Examples of the present disclosure provide a local breakout architecture for text-to-911 services. In one example, local breakout of IMS-based messaging utilizes the same SOS APN used for voice and video calling. This allows the physical location of a roaming mobile device from which a text-to-911 message is received to be used, by the messaging core of the visited network, to route the text-to-911 message to the PSAP that is best positioned to assist the mobile device user. As a result, the user of the mobile device will not receive a bounce-back message. Instead, the PSAP (or emergency responders contacted by the PSAP) may be able to communicate with the mobile device, via text messaging, to confirm receipt of the request for emergency services, to provide instructions to the user, to request additional information from the user, or to exchange other information. These and other aspects of the present disclosure are discussed in further detail with reference to FIGS. 1-4, below.

To further aid in understanding the present disclosure, FIG. 1 illustrates an example system 100 in which examples of the present disclosure for providing text-to-911 services for roaming wireless devices may operate. The system 100 may include any one or more types of communication networks, such as a traditional circuit switched network (e.g., a public switched telephone network (PSTN)) or a packet network such as an Internet Protocol (IP) network (e.g., an IP Multimedia Subsystem (IMS) network), an asynchronous transfer mode (ATM) network, a wired network, a wireless network, and/or a cellular network (e.g., 2G-5G, a long term evolution (LTE) network, a next-generation network, and the like) related to the current disclosure. It should be noted that an IP network is broadly defined as a network that uses Internet Protocol to exchange data packets. Additional example IP networks include Voice over IP (VoIP) networks, Service over IP (SoIP) networks, the World Wide Web, and the like.

In one example, use equipment (UE) 102₁-102ₙ (hereinafter individually referred to as a “UE 102” or collectively referred to as “UEs 102”), may connect to a base station (e.g., eNodeB 104, gNodeB 124, or the like) of a visited network via one or more means, including via a terrestrial radio access network (RAN) (e.g., as in the case of the UE 102ₙ), via non-terrestrial (e.g., satellite) network (e.g., as in the case of the UE 102₁), or via other networks such as public or private WiFi networks. The UEs 102 may include any types of mobile devices that are capable of connecting to a cellular communications network, such as a smart phone, a wearable smart device (e.g., a smart watch, smart glasses, a smart biometric device, or the like), a tablet computer, a laptop computer, a gaming system, an Internet of Things (IoT) device, a connected vehicle (e.g., an autonomous car, a drone, or the like), or the like. In one example, the UEs 102 may include both UEs that subscribe to the services of the network operator who operates the system 100 (for whom the system 100 may comprise a portion of a home network) and UEs that subscribe to the services of a network operator who operates a different system or cellular communications network (for whom the system 100 may comprise a portion of a visited network).

In one particular example, the system 100 may be part of a visited network for the UE 102ₙ (in other words, the UE 102ₙ may be roaming). The visited network may comprise a RAN and a core network. In this case, when a user of the UE 102ₙ attempts to contact emergency services via text message (e.g., via text-to-911 or a similar service), the text message may be received by the base station (e.g., eNodeB 104, gNodeB 124, or the like)). The base station may detect that the text message is a text-to-911 message intended for emergency services and that the UE 102ₙ is roaming and may, in response, forward the text message to an emergency (SOS) APN/DNN 106. In one example, the base station may detect that the text message is intended for emergency services by the UE 102ₙ attempting an emergency attach to the base station.

The SOS APN/DNN 106 may include functionality of both an SOS APN (e.g., for LTE network architectures) and an SOS DNN (e.g., for 5G network architectures). The SOS APN functionality may generally comprise a mobility management entity (MME) 108, a serving gateway (SGW) 110, and a PDN gateway (PGW) 112. The SOS DNN functionality may generally comprise an access and mobility management function (AMF) 126, a session management function (SMF) 128, and a UPF 130.

The MME 108 or AMF 126 may be configured to manage mobility, authentication, and session handling for UEs connecting to the visiting network, including UEs 102. For instance, the MME 108 or AMF 126 may verify that the roaming UE 102ₙ has a valid subscription to its home network and is authenticated and authorized for wireless service in the location from which the UE 102ₙ is attached to the visited network. The MME 108 or AMF 126 may also oversee tracking of the location of the UE 102ₙ when the UE 102ₙ moves between different base stations (e.g., cell towers) of the visited network and during transitions between idle and active states.

The SGW 110 and PGW 112 may collectively comprise an evolved packet core (EPC). The SMF 128 and UPF 130 may collectively comprise a 5G core network. The SGW 110 may be configured to function as an interface between the RAN of which the base station (e.g., eNodeB 104, gNodeB 124, or the like) is a part and a mobile core network of the system 100 (e.g., by routing and forwarding data packets between the eNodeB 104 or gNode4B 124 and the PGW 112). The PGW 112 may be configured to connect the mobile core network of the system 100 to an external PDN. Thus, the PGW 112 may function as ingress and egress point to the EPC from a PDN, such as the Internet. Similarly, the SMF 128 and UPF 130 work collectively to establish a packet data unit (PDU) session for the SOS DNN. The routing and forwarding of data packets between the gNodeB 124 and the IMS core network (e.g., SOS P-CSCF 114) is handled by the UPF 130.

As discussed above, under current practices, the SGW 110 and PGW 112 would work together to route packets of the text-to-911 message from the UE 102ₙ to the IMS core of the UE's home network. Similarly, the SMF 128 and UPF 130 would work together to route packets of the text-to-911 message from the UE 102ₙ to the IMS core of the UE's home network. However, according to examples of the present disclosure, the SGW 110 and PGW 112, or SMF 128 and UPF 130, may work together to route packets of the text-to-911 message from the UE 102ₙ to the IMS core of the visited network (i.e., the network of which the system 100 may be a part).

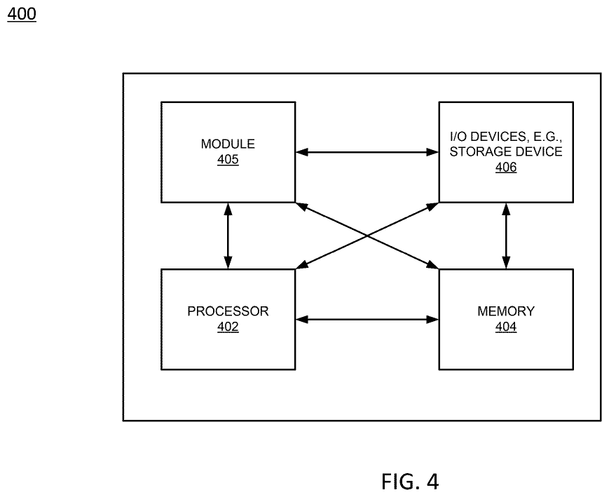

In one example, the IMS core of the visited network may comprise an emergency (SOS) proxy call session control function (P-CSCF) 114 and an Internet Protocol (IP) short message (SM) gateway (GW) 116. The SOS P-CSCF 114 may be configured to route all incoming and outgoing session initiation protocol (SIP) traffic for the UE 102ₙ to the appropriate elements within the IMS core, including the IP SM GW 116. The SOS P-CSCF 114 may comprise one or more physical devices, e.g., one or more computing systems or servers, such as computing system 400 depicted in FIG. 4, and may be configured as described below. It should be noted that as used herein, the terms “configure,” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures or the like which may cause a processing system executing computer-readable instructions, code, and/or programs to function differently depending upon the values of the variables or other data structures that are provided. As referred to herein a “processing system” may comprise a computing device including one or more processors, or cores (e.g., as illustrated in FIG. 4 and discussed below) or multiple computing devices collectively configured to perform various steps, functions, and/or operations in accordance with the present disclosure.

The IP SM GW 116 is configured to operate as an interface between the IMS core (which is based on SIP) and a text to 911 control center (TCC) 118 in an SMS network; thus, the IP SM GW 116 allows users of the UEs 102 to send and receive text messages over an IP network by converting SMS traffic between SIP and SMS.

The TCC 118 provides session-like text communication between the UEs 102 and PSAPs, including PSAP 122. When the TCC 118 receives the text-to-911 message (e.g., in either SIP or short message peer-to-peer (SMPP) message format) from the IP SM GW 116, the TCC 118 may identify a PSAP 122 to which to forward the text-to-911 message (where the PSAP 122 may be one of a plurality of available PSAPs).

As discussed above, current practice is to assign a call or text to the PSAP 122 that is mapped to the component of the access network that is nearest to the calling UE. For instance, in the example of FIG. 1, the text-to-911 message might be routed to the PSAP 122 that is mapped to the eNodeB 104, gNodeB 124, or the like. In one example the TCC 118 may also forward the text-to-911 message to a gateway mobile location center (GMLC) 120. The GMLC 120 may be configured to support location-based services within the system 100. In one example, the GMLC 120 may provide the TCC 118 with the physical location of a UE 102 from which a text-to-911 message was received (which in one example may be an identity of an eNodeB 104, gNodeB 124, or the like to which the UE 102 is attached), and the TCC 118 may then use the physical location of the UE 102 to identify the PSAP 122 that is best situated to respond to the text-to-911 message. Thus, the TCC 118 may select a PSAP 122 to which to forward the text-to-911 message based on the location of the UE 102ₙ.

It should be noted that the system 100 has been simplified. Thus, those skilled in the art will realize that the system 100 may be implemented in a different form than that which is illustrated in FIG. 1, or may be expanded by including additional endpoint devices, access networks, network elements, application servers, etc. without altering the scope of the present disclosure. In addition, system 100 may be altered to omit various elements, substitute elements for devices that perform the same or similar functions, combine elements that are illustrated as separate devices, and/or implement network elements as functions that are spread across several devices that operate collectively as the respective network elements.

For example, the system 100 may include other network elements (not shown) such as border elements, routers, switches, policy servers, security devices, gateways, a content distribution network (CDN) and the like. For example, portions of the IMS core network may comprise a content distribution network (CDN) having ingest servers, edge servers, and the like. Similarly, although only one each of non-terrestrial (e.g., satellite) and terrestrial (e.g., RAN) access network is illustrated, in other examples, the non-terrestrial and terrestrial access networks may each comprise a plurality of different access networks that may interface with the SOS APN 106 independently or in a chained manner. Thus, these and other modifications are all contemplated within the scope of the present disclosure.

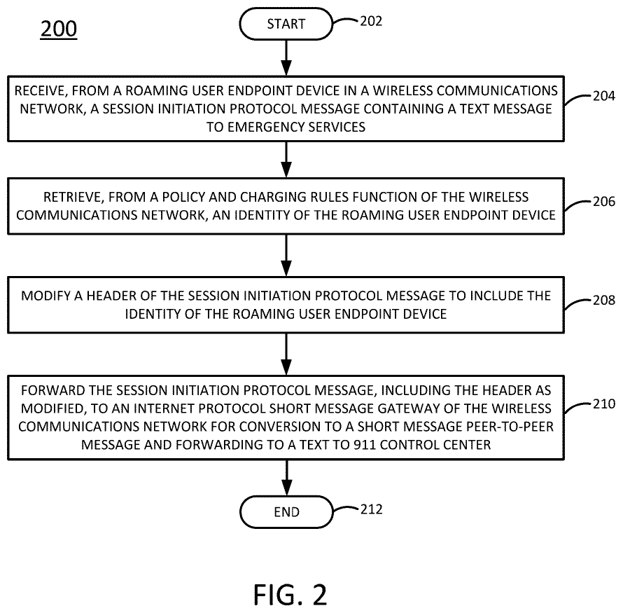

To further aid in understanding the present disclosure, FIG. 2 illustrates a flowchart of an example method 200 for providing text-to-911 services for roaming wireless devices, according to the present disclosure. In one example, the method 200 may be performed by a SOS P-CSCF, such as the SOS P-CSCF 114 illustrated in FIG. 1 or one or more components thereof (e.g., a processor or controller of the SOS P-CSCF 114). However, in other examples, the method 200 may be performed by another device, such as the computing system 400 of FIG. 4, discussed in further detail below. For the sake of discussion, the method 200 is described below as being performed by a processing system (where the processing system may comprise a component of a SOS P-CSCF 114, the computing system 400, or another device).

The method 200 begins in step 202. In step 204, the processing system may receive, from a roaming user endpoint device in a wireless communications network, a session initiation protocol message containing a text message to emergency services.

In one example, the roaming user endpoint device may comprise any type of cellular-enabled mobile device, such as a smart phone, a wearable smart device (e.g., a smart watch, smart glasses, a smart biometric device, or the like), a tablet computer, a laptop computer, a gaming system, an Internet of Things (IoT) device, a connected vehicle (e.g., an autonomous car, a drone, or the like), or the like.

In one example, the wireless communications network may be a visited network for the roaming user endpoint device (i.e., the home network of the roaming user endpoint device is a different wireless communications network). In one example, both the home network and the visited network may comprise cellular communications networks. For instance, the home network may comprise a cellular communications network operated by a first cellular network operator, while the visited network may comprise a cellular communications network operated by a second cellular network operator. The roaming user endpoint device may be a valid subscriber of the home network. However, the coverage of the home network may not extend to the current physical location of the roaming user endpoint device. Thus, the roaming user endpoint device may roam by attaching to the visited network, whose coverage may extend to the current physical location of the roaming user endpoint device. The roaming user endpoint device may be authenticated and authorized for wireless service on the visited network.

The text message to emergency services may be directed to 911, 112, or another emergency number. In one example, the roaming user endpoint device may detect that the text message is addressed to a number associated with emergency services and may, in response, automatically create an emergency session (e.g., an IPMS emergency session created via a PDN connection request) and send the SIP message to the processing system.

In step 206, the processing system may retrieve, from a policy and charging rules function (PCRF) of the wireless communications network, an identity of the roaming user endpoint device.

In one example, the identity of the roaming user endpoint device may comprise at least one of: an international mobile subscriber identity (IMSI; e.g., a unique fifteen-digit number that is stored in the subscriber identity module of the roaming user endpoint device and uniquely identifies the roaming user endpoint device as a mobile subscriber on a global system for mobile communications (GSM) or a universal mobile telecommunications system (UMTS) network), an international mobile equipment identity (IMEI; e.g., a unique numeric identifier for 3GPP, integrated digital enhanced network (iDEN), and some satellite devices), or a mobile station international subscriber directory number (MSISDN; e.g., what would conventionally be considered the phone number of the roaming user endpoint device, or the number via which other devices would call or send text messages to the roaming user endpoint device). In one example, the identity of the roaming user endpoint device may be retrieved in the manner described in 3GPP Technical Specification 23.167, Annex K.

In step 208, the processing system may modify a header of the session initiation protocol message to include the identity of the roaming user endpoint device.

In one example, the header of the SIP message may be a header that includes a SIP uniform resource locator (URI) or tel URI that represents the identity of the roaming user endpoint device, such as a P-asserted-identity header. In one example, modifying the header in accordance with step 208 may comprise modifying the header to contain the identity of the roaming user endpoint device. For instance, a P-asserted-identity header may be modified as P-Asserted-Identity: <sip:user@isp.com> or P-Asserted-Identity: <tel:+1234567890>.

In one example, the header is modified to contain the MSISDN of the roaming user endpoint device (e.g., P-Asserted-Identity: tel:+1234567890). If, however, the processing system is unable to obtain the MSISDN of the user endpoint device from the PCRF, then the processing system may instead modify the header to populate the header with the following string: +1-911-[digits 8-14 of the IMEI of the roaming user endpoint device]. The IMEI may be obtained from the P-preferred-identity header of the SIP message. For instance, a P-asserted-identity header may be modified as P-Asserted-Identity: <tel:+1-911-8910111>.

In step 210, the processing system may forward the session initiation protocol message, including the header as modified, to an internet protocol short message gateway of the wireless communication network for conversion to a short message peer-to-peer message and forwarding to a text to 911 control center.

As discussed above, the TCC will determine a PSAP to which to forward the SIP message. If the P-asserted-identity header of the SIP message has been modified to contain the MSISDN of the roaming user endpoint device, then the PSAP may utilize the MSISDN of the roaming user endpoint device to communicate with the roaming user endpoint device (e.g., via further text messages containing acknowledgement of the text message to emergency services, queries for further information, instructions for the user of the roaming user endpoint device, or the like).

Alternatively, if the P-asserted-identity header of the SIP message has been modified to contain the string that includes +1-911-[digits 8-14 of the IMEI of the roaming user endpoint device], then the PSAP will recognize that the roaming user endpoint device may not be able to place an audible call. In this case, the PSAP may not send a bounce-back message.

In a further example, the TCC may, upon receiving the SMPP message from the IP SM GW, launch a location request to the GMLC to request the current physical location of the roaming user endpoint device. The TCC may utilize the current physical location of the roaming user endpoint device, as indicated by the GMLC to select a specific PSAP to which to route the SMPP message.

The method 200 may end in step 212.

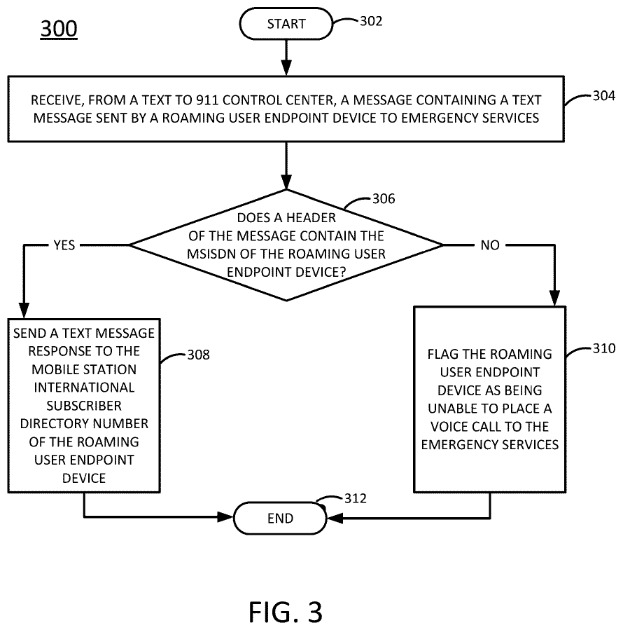

FIG. 3 illustrates a flowchart of an example method 300 for providing text-to-911 services for roaming wireless devices may operate, according to the present disclosure. In one example, the method 300 may be performed by a PSAP, such as the PSAP 122 illustrated in FIG. 1 or one or more components thereof (e.g., a processor or controller of the PSAP 122). However, in other examples, the method 300 may be performed by another device, such as the computing system 400 of FIG. 4, discussed in further detail below. For the sake of discussion, the method 300 is described below as being performed by a processing system (where the processing system may comprise a component of a PSAP 122, the computing system 400, or another device).

The method 300 begins in step 302. In step 304, the processing system may receive, from a text-to-911 control center, a message containing a text message sent by a roaming user endpoint device to emergency services.

In one example, the roaming user endpoint device may comprise any type of cellular-enabled mobile device, such as a smart phone, a wearable smart device (e.g., a smart watch, smart glasses, a smart biometric device, or the like), a tablet computer, a laptop computer, a gaming system, an Internet of Things (IoT) device, a connected vehicle (e.g., an autonomous car, a drone, or the like), or the like.

In one example, roaming user endpoint device may have sent the text-to-911 message while attached to a visited wireless communications network (i.e., the home wireless communications network of the roaming user endpoint device is a different wireless communications network that the network the TCC belongs to). In one example, both the home wireless communications network and the visited wireless communications network may comprise cellular communications networks. For instance, the home wireless communications network may comprise a cellular communications network operated by a first cellular network operator, while the visited wireless communications network may comprise a cellular communications network operated by a second cellular network operator. The roaming user endpoint device may be a valid subscriber of the home wireless communications network. However, the coverage of the home wireless communications network may not extend to the current physical location of the roaming user endpoint device. Thus, the roaming user endpoint device may roam by attaching to the visited wireless communications network, whose coverage may extend to the current physical location of the roaming user endpoint device. The roaming user endpoint device may be authenticated and authorized for wireless service on the visited wireless communications network.

The text message sent by the roaming user endpoint device to emergency services may be directed to 911, 112, or another emergency number. In one example, the roaming user endpoint device may detect that the text message is addressed to a number associated with emergency services and may, in response, automatically create an emergency session (e.g., an IPMS emergency session created via a PDN connection request) and send the SIP message to the processing system.

In one example, the message received from the TCC may comprise an SMPP message. A header of the SMPP message, such as a P-asserted-identity header, may contain an identity of the roaming user endpoint device. For instance, the header may contain at least one of: an IMEI of the roaming user endpoint device, an IMSI of the roaming user endpoint device, or an MSISDN of the roaming user endpoint device, depending upon what information an SOS PCSCF that processed the text-to-911 message was able to retrieve from a PCRF of the wireless communications network to which the roaming user endpoint device is attached.

In step 306, the processing system may determine whether a header of the message contains a mobile station international subscriber directory number of the roaming user endpoint device.

As discussed above, in one example, the header of the message may contain at least one of: an IMEI of the roaming user endpoint device, an IMSI of the roaming user endpoint device, or an MSISDN of the roaming user endpoint device. If SOS PCSCF that processed the text-to-911 message was able to retrieve the MSISDN, then the MSISDN may be included in a P-asserted-identity header (or another header) of the message, e.g., in the format P-Asserted-Identity: <tel:+1234567890>. If, however, the SOS PCSCF is unable to retrieve the MSISDN, then the IMEI may be included in a P-asserted-identity header (or another header) of the message, e.g., in the format P-Asserted-Identity: <tel: +1-911-8910111>.

If the processing system concludes in step 306 that a header of the message does contain a mobile station international subscriber directory number of the roaming user endpoint device, then the processing system may proceed to step 308. In step 308, the processing system may send a text message to the mobile station international subscriber directory number of the roaming user endpoint device.

As discussed above, the processing system may utilize the MSISDN of the roaming user endpoint device to communicate with the roaming user endpoint device (e.g., via further text messages containing acknowledgement of the text message to emergency services, queries for further information, instructions for the user of the roaming user endpoint device, or the like). For instance, the text message response may indicate that the text message to emergency services has been received and is being assigned to emergency response personnel, or may indicate an approximate wait time for emergency response personnel to arrive. In other examples, the text message response may ask the user for additional information about the circumstances that prompted the text to emergency services (e.g., the nature and/or extent of any physical injuries, whether any individuals are still in immediate danger, possible hazards for emergency response personnel, photos from the user's location, or the like) or may provide instructions to the user to facilitate the provision of emergency services (e.g., where to move to, if possible, to remain safe until emergency response personnel arrive, how to treat injuries or prevent further injury until emergency response personnel arrive, or the like).

If, however, the processing system concludes in step 306 that a header of the message does not contain a mobile station international subscriber directory number of the roaming user endpoint device, then the processing system may proceed to step 310. In step 310, the processing system may flag the roaming user endpoint device as being unable to place a voice call to the emergency services.

In one example, if the P-asserted-identity header of the SIP message has been modified to contain a string that includes +1-911-[digits 8-14 of the IMEI of the roaming user endpoint device], then the processing system will recognize that the roaming user endpoint device may not be able to place an audible call. In this case, the processing system may flag the roaming user endpoint device (e.g., in a data structure that tracks calls and texts to emergency services) as being unable to place a voice call to emergency services. Flagging the roaming user endpoint device in this manner may prevent the processing system from sending a bounce-back message to the roaming user endpoint device.

The method 300 may end in step 312.

Although not expressly specified above, one or more steps of the method 200 or method 300 may include a storing, displaying and/or outputting step as required for a particular application. In other words, any data, records, fields, and/or intermediate results discussed in the method can be stored, displayed and/or outputted to another device as required for a particular application. Furthermore, operations, steps, or blocks in FIG. 2 or FIG. 3 that recite a determining operation or involve a decision do not necessarily require that both branches of the determining operation be practiced. In other words, one of the branches of the determining operation can be deemed as an optional step. However, the use of the term “optional step” is intended to only reflect different variations of a particular illustrative embodiment and is not intended to indicate that steps not labelled as optional steps to be deemed to be essential steps. Furthermore, operations, steps or blocks of the above described method(s) can be combined, separated, and/or performed in a different order from that described above, without departing from the examples of the present disclosure.

FIG. 4 depicts a high-level block diagram of a computing device specifically programmed to perform the functions described herein. For example, any one or more components or devices illustrated in FIG. 1 or described in connection with the method 200 or method 300 may be implemented as the system 400. For instance, the SOS P-CSCF 114 or PSAP 122 of FIG. 1 (such as might be used to perform the method 200 or the method 300) could be implemented as illustrated in FIG. 4. As depicted in FIG. 4, the system 400 comprises a hardware processor element 402, a memory 404, a module 405 for providing text-to-911 services for roaming wireless devices, and various input/output (I/O) devices 406.

The hardware processor 402 may comprise, for example, a microprocessor, a central processing unit (CPU), or the like. The memory 404 may comprise, for example, random access memory (RAM), read only memory (ROM), a disk drive, an optical drive, a magnetic drive, and/or a Universal Serial Bus (USB) drive. The module 405 for providing text-to-911 services for roaming wireless devices may include circuitry and/or logic for processing and routing text-to-911 messages from roaming wireless devices in a wireless communications network. The input/output devices 406 may include, for example, storage devices (including but not limited to, a tape drive, a floppy drive, a hard disk drive or a compact disk drive), a receiver, a transmitter, a fiber optic communications line, an output port, or a user input device (such as a keyboard, a keypad, a mouse, and the like).

Although only one processor element is shown, it should be noted that the computer may employ a plurality of processor elements. Furthermore, although only one specific-purpose computer is shown in the Figure, if the method(s) as discussed above is implemented in a distributed or parallel manner for a particular illustrative example, i.e., the steps of the above method(s) or the entire method(s) are implemented across multiple or parallel specific-purpose computers, then the specific-purpose computer of this Figure is intended to represent each of those multiple specific-purpose computers. Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented.

It should be noted that the present disclosure can be implemented in software and/or in a combination of software and hardware, e.g., using application specific integrated circuits (ASIC), a programmable logic array (PLA), including a field-programmable gate array (FPGA), or a state machine deployed on a hardware device, a computer or any other hardware equivalents, e.g., computer readable instructions pertaining to the method(s) discussed above can be used to configure a hardware processor to perform the steps, functions and/or operations of the above disclosed method(s). In one example, instructions and data for the present module or process 405 for providing text-to-911 services for roaming wireless devices can be loaded into memory 404 and executed by hardware processor element 402 to implement the steps, functions or operations as discussed above in connection with the example method 200 or example method 300. Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method(s) can be perceived as a programmed processor or a specialized processor. As such, the present module 405 for providing text-to-911 services for roaming wireless devices (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. More specifically, the computer-readable storage device may comprise any physical devices that provide the ability to store information such as data and/or instructions to be accessed by a processor or a computing device such as a computer or an application server.

While various examples have been described above, it should be understood that they have been presented by way of example only, and not limitation. Thus, the breadth and scope of a preferred example should not be limited by any of the above-described example examples, but should be defined only in accordance with the following claims and their equivalents.

What is claimed is:

1. A method comprising:
receiving, by a processing system including at least one processor from a roaming user endpoint device in a wireless communications network, a session initiation protocol message containing a text message to emergency services;
retrieving, by the processing system from a policy and charging rules function of the wireless communications network, an identity of the roaming user endpoint device;
modifying, by the processing system, a header of the session initiation protocol message to include the identity of the roaming user endpoint device; and
forwarding, by the processing system, the session initiation protocol message, including the header as modified, to an internet protocol short message gateway of the wireless communication network for conversion to a short message peer-to-peer message and forwarding to a text to 911 control center.

2. The method of claim 1, wherein the wireless communications network is a visited network for the roaming user endpoint device, and the roaming user endpoint device is subscribed to a service of a home network that is different from the visited network.

3. The method of claim 2, wherein the receiving, the retrieving, the modifying, and the forwarding are performed within an internet protocol multimedia subsystem core of the visited network, without forwarding the text message to the home network.

4. The method of claim 2, wherein the processing system is part of an emergency proxy call session control function of the visited network.

5. The method of claim 2, wherein the visited network and the home network are both cellular communications networks.

6. The method of claim 1, wherein the text message to emergency services is directed to at least one of: 911 or 112.

7. The method of claim 1, wherein the identity of the roaming user endpoint device comprises at least one of: an international mobile subscriber identity of the roaming user endpoint device, an international mobile equipment identity of the roaming user endpoint device, or a mobile station international subscriber directory number of the roaming user endpoint device.

8. The method of claim 7, wherein the header comprises a p-asserted-identity header.

9. The method of claim 8, wherein the modifying comprises modifying the header to contain the mobile station international subscriber directory number of the roaming user endpoint device.

10. The method of claim 8, wherein the modifying comprises modifying the header to contain a string defined as +1-911-[digits 8-14 of the international mobile equipment identity of the roaming user endpoint device].

11. The method of claim 8, wherein the international mobile equipment identity of the roaming user endpoint device is obtained from a header of the session initiation protocol message.

12. The method of claim 11, wherein the header of the session initiation protocol message comprises a p-preferred-identity header.

13. The method of claim 1, wherein the text to 911 control center comprises a function of the wireless communications network that selects, from among a plurality of public safety answering points, a selected public safety answering point to respond to the text message to emergency services.

14. A non-transitory computer-readable medium storing instructions which, when executed by a processing system including at least one processor, cause the processing system to perform operations, the operations comprising:
receiving, from a roaming user endpoint device in a wireless communications network, a session initiation protocol message containing a text message to emergency services;
retrieving, from a policy and charging rules function of the wireless communications network, an identity of the roaming user endpoint device;
modifying a header of the session initiation protocol message to include the identity of the roaming user endpoint device; and
forwarding the session initiation protocol message, including the header as modified, to an internet protocol short message gateway of the wireless communication network for conversion to a short message peer-to-peer message and forwarding to a text to 911 control center.

15. The non-transitory computer-readable medium of claim 14 wherein the wireless communications network is a visited network for the roaming user endpoint device, and the roaming user endpoint device is subscribed to a service of a home network that is different from the visited network.

16. The non-transitory computer-readable medium of claim 15, wherein the receiving, the retrieving, the modifying, and the forwarding are performed within an internet protocol multimedia subsystem core of the visited network, without forwarding the text message to the home network.

17. The non-transitory computer-readable medium of claim 15, wherein the processing system is part of an emergency proxy call session control function of the visited network.

18. The non-transitory computer-readable medium of claim 14, wherein the identity of the roaming user endpoint device comprises at least one of: an international mobile subscriber identity of the roaming user endpoint device, an international mobile equipment identity of the roaming user endpoint device, or a mobile station international subscriber directory number of the roaming user endpoint device.

19. The non-transitory computer-readable medium of claim 18, wherein the header comprises a p-asserted-identity header.

20. A system comprising:
a processing system including at least one processor; and
a non-transitory computer-readable medium storing instructions which, when executed by the processing system, cause the processing system to perform operations, the operations comprising:
receiving, from a roaming user endpoint device in a wireless communications network, a session initiation protocol message containing a text message to emergency services;
retrieving, from a policy and charging rules function of the wireless communications network, an identity of the roaming user endpoint device;
modifying a header of the session initiation protocol message to include the identity of the roaming user endpoint device; and
forwarding the session initiation protocol message, including the header as modified, to an internet protocol short message gateway of the wireless communication network for conversion to a short message peer-to-peer message and forwarding to a text to 911 control center.
